(19) United States
(12) Patent Application Publication
(10) Pub. No.: US 2024/0078563 A1
(43) Pub. Date: Mar. 7, 2024

(54) METHOD AND SYSTEM FOR IDENTIFYING FRAUD MERCHANTS DESCRIPTORS

(71) Applicant: JPMORGAN CHASE BANK, N.A., New York, NY (US)

(72) Inventors: Justin HOWE, San Francisco, CA (US); Justin CHACE, London (GB)

(21) Appl. No.: 17/930,390

(22) Filed: Sep. 7, 2022

(51) Int. Cl. G06Q 30/00; G06Q 20/40

(52) U.S. Cl. CPC G06Q 30/0185; G06Q 20/4016

(57) ABSTRACT

A method for identifying fraud merchant descriptors (that is implemented by disclosed apparatus) is disclosed. The method comprises matching one or more input descriptor with a first database comprising one or more valid trademarks of one or more clients; identifying a set of valid merchant descriptors and a set of suspected merchant descriptors, from the one or more input merchant descriptors based on the matching; identifying a target client associated with each merchant descriptor in the set of suspected merchant descriptors; communicating the each merchant descriptor from the set of suspected merchant descriptors to the associated target client; receiving an authentication decision associated with each merchant descriptor from the set of suspected merchant descriptors; and identifying one or more merchant descriptors from the set of suspected merchant descriptor as fraud merchant descriptor in an event the authentication decision associated with said one or more merchant descriptors is negative.

### BACKGROUND

### Field of the Disclosure

This technology generally relates to methods and systems for identifying fraud merchants descriptors, and more particularly to methods and systems for identifying and blocking transactions from merchants associated with fraud merchant descriptors as well as the onboarding of such merchants.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, the nature of worldwide credit card fraud has changed. The credit card abuse by merchants, especially on the Internet, has become a growing threat for both the credit card organizations themselves, as well as the acquirer banks. The amount and cost of online fraud are increasing. For merchant acquirers, one of the most common and costly causes of financial loss is merchant fraud; fake merchant accounts that appear as legitimate businesses but are just fronts for various fraud schemes. Although a fraudulent charge may result from a purchase at a legitimate merchant by a fraudster, fraudulent charges can also result from the creation of an illegitimate merchant pretending to be a legitimate one. The creation of these fraudulent merchant accounts is possible, because the networks have placed the responsibility for merchant due diligence on the acquirers.

Merchant acceptance networks do run programs to prevent merchants that sell counterfeited merchandise. However, they do not have any programs to systemically detect a merchant whose bank statement descriptor is already trademarked. Further, there is no systemic process in place today in the credit card ecosystem to govern which bank statement descriptors a merchant can use. As a result, many of the merchants have imposters that misuse their trademarked names or similar names to conduct business and/or facilitate the cash-out of hacked credit card credentials.

Therefore, there is a need for a specialized approach that can overcome at least the above mentioned limitations by providing a method and system for identifying and blocking transactions from merchants associated with fraud merchant descriptors as well as the onboarding of such clients.

### SUMMARY

The present disclosure, through one or more of its various aspects, embodiments, and/or specific features or sub-components, provides, inter alia, various systems, servers, devices, methods, media, programs, and platforms for identifying and blocking transactions from merchants associated with fraud merchant descriptors as well as the on boarding of such clients.

According to an aspect of the present disclosure, a method for identifying fraud merchant descriptors is disclosed. The method is implemented by at least one processor. The method may include matching, by the at least one processor, one or more input descriptor with a first database comprising one or more valid trademarks of one or more clients; identifying, by the at least one processor, a set of valid merchant descriptors and a set of suspected merchant descriptors, from the one or more input merchant descriptors based on the matching; identifying, by the at least one processor, a target client associated with each merchant descriptor in the set of suspected merchant descriptors; communicating, by a communication module, the each merchant descriptor from the set of suspected merchant descriptors to the associated target client; receiving, by the at least one processor, an authentication decision associated with each merchant descriptor from the set of suspected merchant descriptors; and identifying, by the at least one processor, one or more merchant descriptors from the set of suspected merchant descriptors as fraud merchant descriptor in an event the authentication decision associated with said one or more merchant descriptors is negative.

In accordance with an exemplary embodiment, the one or more input descriptor names is retrieved from one of a second database and a merchant onboarding portal.

In accordance with an exemplary embodiment, the method may further include sending, by the at least one processor, a notification to the merchant onboarding portal, wherein the notification comprises the identified fraud merchant descriptor; and blocking, by the at least one processor, onboarding of a merchant associated with the fraud merchant descriptor.

In accordance with an exemplary embodiment, the second database comprises one or more merchant descriptors retrieved from one or more payment portals.

In accordance with an exemplary embodiment, the set of suspected merchant descriptors comprises one or more from the one or more input merchant descriptors based on the matching, further comprises: identifying, by the at least one processor, one or more suspected merchant descriptors, wherein a similarity between the one or more suspected merchant descriptors and the one or more valid trademarks in the first database is within a predefined threshold.

In accordance with an exemplary embodiment, the identifying a set of valid merchant descriptors and a set of suspected merchant descriptors, from the one or more input merchant descriptors based on the matching, further comprises: determining, by the at least one processor, a similarity score for each input merchant descriptor based on the matching of the one or more input merchant descriptors with the first database; identifying, by the at least one processor, each merchant descriptor as one of a valid or suspected based on the similarity score, wherein an input merchant descriptor is identified as a valid merchant descriptor in an event the similarity score of the input merchant descriptor is 100% and wherein an input merchant descriptor is identified as a suspected merchant descriptor in an event the similarity score of the input merchant descriptor is within a predefined threshold.

In accordance with an exemplary embodiment, the method may further include applying, by the at least one processor, a block rule for blocking transactions, on the validation portal, associated with the fraud merchant descriptor.

In accordance with an exemplary embodiment, the method may further include receiving, by the at least one processor, a new transaction request comprising a new merchant descriptor; and automatically blocking, by the at least one processor, the transaction request based on the block rule in an event the new merchant descriptor is a fraud merchant descriptor.

In accordance with an exemplary embodiment, the method may further include sending, by the at least one processor, a notification to one or more payment networks, wherein the notification comprises the identified fraud merchant descriptor.

In accordance with an exemplary embodiment, the one or more input descriptors appear in a card transaction, wherein the card transaction is one of a credit card transaction, a debit card transaction and a EMV transaction.

According to an aspect of the present disclosure, an apparatus for identifying and blocking unauthorised merchants and transactions is disclosed. The apparatus comprises a processor; a communication module; a memory unit connected to the processor and the communication module, wherein the processor may be configured to match one or more input descriptor with a first database comprising one or more valid trademarks of one or more clients; identify a set of valid merchant descriptors and a set of suspected merchant descriptors, from the one or more input merchant descriptors based on the matching; identify a target client associated with each merchant descriptor in the set of suspected merchant descriptors; and wherein the communication module is configured to communicate the each merchant descriptor from the set of suspected merchant descriptors to the associated target client; and wherein the processor is configured to receive an authentication decision associated with each merchant descriptor from the set of suspected merchant descriptors; and identify one or more merchant descriptors from the set of suspected merchant descriptor as fraud merchant descriptor in an event the authentication decision associated with said one or more merchant descriptors is negative.

In accordance with an exemplary embodiment, the at least one processor, for identifying the set of valid merchant descriptors and a set of suspected merchant descriptors, from the one or more input merchant descriptors based on the matching, is further configured to identify one or more suspected merchant descriptors, wherein a similarity between the one or more suspected merchant descriptors and the one or more valid trademarks in the first database is within a predefined threshold.

In accordance with an exemplary embodiment, the at least one processor, for identifying a set of valid merchant descriptors and a set of suspected merchant descriptors, from the one or more input merchant descriptors based on the matching, is further configured to determine a similarity score for each input merchant descriptor based on the matching of the one or more input merchant descriptors with the first database; and identify each merchant descriptor as one of a valid or suspected based on the similarity score, wherein an input merchant descriptor is identified as a valid merchant descriptor in an event the similarity score of the input merchant descriptor is 100% and wherein an input merchant descriptor is identified as a suspected merchant descriptor in an event the similarity score of the input merchant descriptor is within a predefined threshold.

In accordance with an exemplary embodiment, the at least one processor is further configured to apply a block rule for blocking transactions, on the validation portal, associated with the fraud merchant descriptor.

In accordance with an exemplary embodiment, the at least one processor is further configured to receive a new transaction request comprising a new merchant descriptor; and automatically block the transaction request based on the block rule in an event the new merchant descriptor is a fraud merchant descriptor.

In accordance with an exemplary embodiment, the at least one processor is further configured to send a notification to one or more payment networks, wherein the notification comprises the identified fraud merchant descriptor.

In accordance with an exemplary embodiment, the one or more input descriptors appear in a card transaction, wherein the card transaction is one of a credit card transaction, a debit card transaction and a EMV transaction.

According to an aspect of the present disclosure, a non-transitory computer readable storage medium storing instructions identifying and blocking unauthorised merchants and transactions is disclosed. The storage medium comprises executable code which, when executed by a processor, causes the processor to: match one or more input descriptors with a first database comprising one or more valid trademarks of one or more clients; identify a set of valid merchant descriptors and a set of suspected merchant descriptors, from the one or more input merchant descriptors based on the matching; identify a target client associated with each merchant descriptor in the set of suspected merchant descriptors; and causes the communication module to: communicate the each merchant descriptor from the set of suspected merchant descriptors to the associated target client; and further causes the processor to: receive an authentication decision associated with each merchant descriptor from the set of suspected merchant descriptors; and identify one or more merchant descriptors from the set of suspected merchant descriptors as fraud merchant descriptor in an event the authentication decision associated with said one or more merchant descriptors is negative.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary apparatus for identifying and blocking unauthorised merchants and transactions in accordance with an exemplary embodiment.

FIG. 2 illustrates an exemplary diagram of a network environment for identifying and blocking unauthorised merchants and transactions in accordance with an exemplary embodiment.

FIG. 3 shows an exemplary apparatus for implementing a method for identifying and blocking unauthorised merchants and transactions based on an execution of one or more instructions, in accordance with an exemplary embodiment.

FIG. 4 is a flowchart of an exemplary process for implementing a method apparatus for identifying and blocking unauthorised merchants and transactions based on an execution of one or more instructions, in accordance with an exemplary embodiment.

FIG. 5 is a flow diagram that illustrates an exemplary method for blocking onboarding of a fraudulent merchant, in accordance with an exemplary embodiment.

FIG. 6 is a flow diagram that illustrates an exemplary method for identifying suspected or valid merchants, in accordance with an exemplary embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

In addition, all logical units/controller described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the invention. It will be apparent however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

To overcome the problems associated with fraudulent transactions and onboarding of merchants with fraudulent merchant descriptors, the present disclosure provides a method and system for identifying and blocking unauthorised merchants and transactions. The apparatus or system first receives a request for transaction or onboarding of a new merchant with the merchant onboarding portal. The request is received from a merchant that is associated with a merchant descriptor that may be referred to as an input merchant descriptor. In an example, the input merchant descriptor may comprise merchant descriptor name, acquiring identifiers, and countries, etc. The one or more input descriptors may appear in a card transaction, wherein the card transaction is one of a credit card transaction, a debit card transaction and a EMV transaction.

The system is configured to match input merchant descriptor with a first database comprising valid trademarks of clients. The clients are the entities that have an association with the merchant service provider. Further, the system identifies a set of valid merchant descriptors and a set of suspected merchant descriptors, from the input merchant descriptors. This identification is based on the matching performed by the system. Further, the system identifies a target client associated with each merchant descriptor in the set of suspected merchant descriptors. In an example, the client descriptor is ‘ABC’ which is a valid trademark owned by the client ‘ABC’ but the input merchant descriptor is ‘ABC-XX’. Thus, the system may identify ‘ABC-XX’ as a suspected merchant descriptor. Further, the system communicates this suspected merchant descriptor of ‘ABC-XX’ to the associated target client, i.e., ‘ABC’. ABC company/individual confirms whether or not this suspected merchant descriptor is their own trademark and/or is an authenticated merchant descriptor and makes an authentication decision on the same. Thus, the system further receives the authentication decision associated with the suspected merchant descriptor from the client. Further, the system identifies the input merchant descriptor as a valid merchant descriptor or a fraud merchant descriptor based on the authentication decision associated with said input merchant descriptor received from the client. Based on this decision, the system allows the transaction of the new merchant with the input merchant descriptor or onboarding of the new merchant with the merchant onboarding portal. Alternatively, the system applies a block rule for blocking the transaction of the new merchant with the input merchant descriptor or onboarding of the new merchant with the merchant onboarding portal.

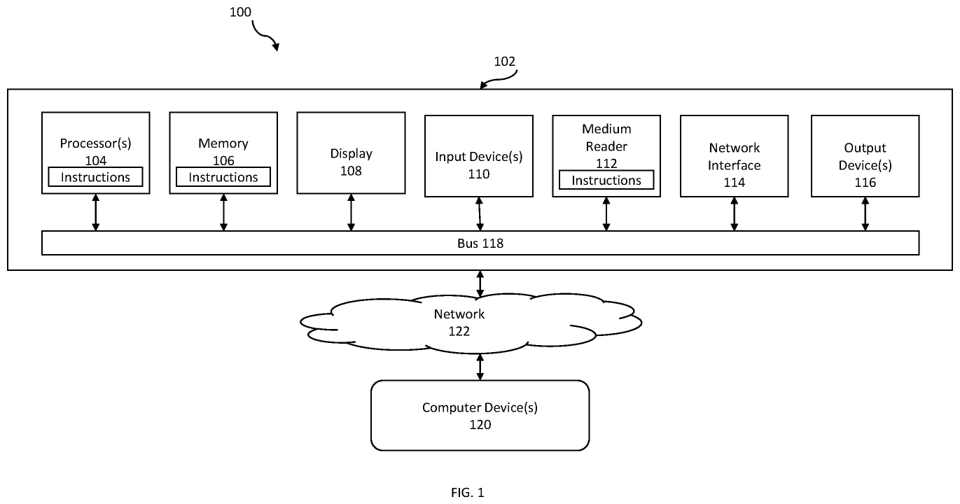

FIG. 1 is an exemplary system for use in accordance with the embodiments described herein. The system 100 is generally shown and may include a computer system 102, also known as computing device 102 or apparatus 102, which is generally indicated to provide for identifying and blocking unauthorised merchants and transactions in accordance with an exemplary embodiment.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. As regards the present invention, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for identifying and blocking unauthorised merchants and transactions based on an execution of one or more instructions.

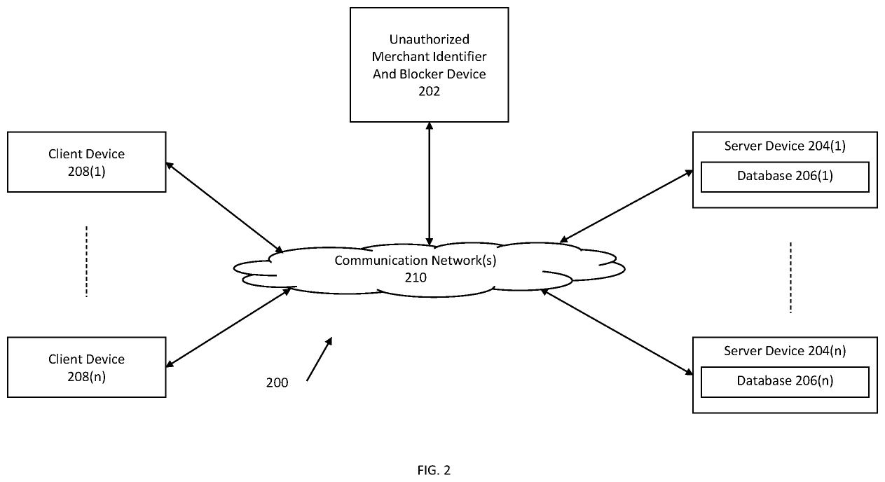

Referring to FIG. 2, a schematic of an exemplary network environment 200 for implementing a method for identifying and blocking unauthorised merchants and transactions is illustrated in accordance with an exemplary embodiment. In an exemplary embodiment, the method is executable on any networked computer platform, such as, for example, a personal computer (PC).

The method for identifying and blocking unauthorised merchants and transactions may be implemented by an unauthorized merchant identifier and blocker (UMIB) device 202. The UMIB device 202 may be the same or similar to the computer system 102 as described with respect to FIG. 1. The UMIB device 202 may store one or more applications that can include executable instructions that, when executed by the UMIB device 202, cause the UMIB device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the UMIB device 202 itself, may be located in virtual server(s) running in a cloud-based computing environment rather than being tied to one or more specific physical network computing devices. Also, the application(s) may be running in one or more virtual machines (VMs) executing on the UMIB device 202. Additionally, in one or more embodiments of this technology, virtual machine(s) running on the UMIB device 202 may be managed or supervised.

In the network environment 200 of FIG. 2, the UMIB device 202 is coupled to a plurality of server devices 204(1)-204(n) that hosts a plurality of databases 206(1)-206(n), and also to a plurality of client devices 208(1)-208(n) via communication network(s) 210. A communication interface of the UMIB device 202, such as the network interface 114 of the computer system 102 of FIG. 1, operatively couples and communicates between the UMIB device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the UMIB device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and UMIB devices that efficiently implement a method for identifying and blocking fraud merchant descriptors, the method being implemented by at least one processor.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The UMIB device 202 may be a standalone device or integrated with one or more other devices or apparatuses, such as one or more of the server devices 204(1)-204(n), for example. In one particular example, the UMIB device 202 may include or be hosted by one of the server devices 204(1)-204(n), and other arrangements are also possible. Moreover, one or more of the devices of the UMIB device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the UMIB device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data related to copyrights and trademarks owned by clients (and also related data such as merchant descriptor name, acquiring identifiers, and countries, etc.).

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the UMIB device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the UMIB device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the UMIB device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the UMIB device 202, the server devices 204(1)-204(n), or the client devices 208(1)-208(n), for example, may be configured to operate as virtual instances on the same physical machine. In other words, one or more of the UMIB device 202, the server devices 204(1)-204(n), or the client devices 208(1)-208(n) may operate on the same physical device rather than as separate devices communicating through communication network(s) 210. Additionally, there may be more or fewer UMIB devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

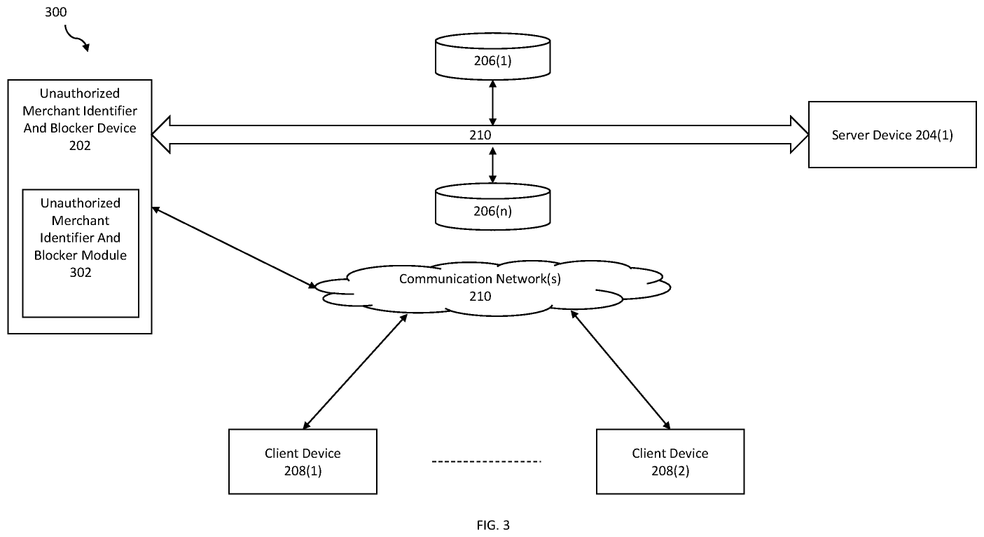

FIG. 3 illustrates an exemplary system for implementing a method for identifying unauthorised merchants and transactions based on an execution of one or more instructions, in accordance with an exemplary embodiment. As illustrated in FIG. 3, according to exemplary embodiments, the system 300 may comprise an UMIB device 202 including an unauthorized merchant identifier and blocker (UMIB) module 302 that may be connected to a server device 204(1) and one or more repository 206(1) 206(n) via a communication network 210, but the disclosure is not limited thereto.

The UMIB device 202 is described and shown in FIG. 3 as including unauthorized merchant identifier and blocker (UMIB) module 302, although it may include other rules, policies, modules, databases, or applications, for example. As will be described below, the unauthorized merchant identifier and blocker module 302 is configured to implement a method for identifying and blocking unauthorised merchants and transactions.

An exemplary process 300 for implementing a mechanism for identifying and blocking unauthorised merchants and transactions based on an execution of one or more instructions by utilizing the network environment of FIG. 2 is shown as being executed in FIG. 3. Specifically, a first client device 208(1) and a second client device 208(2) are illustrated as being in communication with UMIB device 202. In this regard, the first client device 208(1) and the second client device 208(2) may be “clients” of the UMIB device 202 and are described herein as such. Nevertheless, it is to be known and understood that the first client device 208(1) and/or the second client device 208(2) need not necessarily be “clients” of the UMIB device 202, or any entity described in association therewith herein. Any additional or alternative relationship may exist between either or both of the first client device 208(1) and the second client device 208(2) and the UMIB device 202, or no relationship may exist.

Further, UMIB device 202 is illustrated as being able to access the one or more repositories 206(1) . . . 206(n). The UMIB module 302 may be configured to access these repositories/databases for implementing a method for providing for identifying unauthorised merchants and transactions based on an execution of one or more instructions.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the UMIB device 202 via broadband or cellular communication. Of course, these embodiments are merely exemplary and are not limiting or exhaustive.

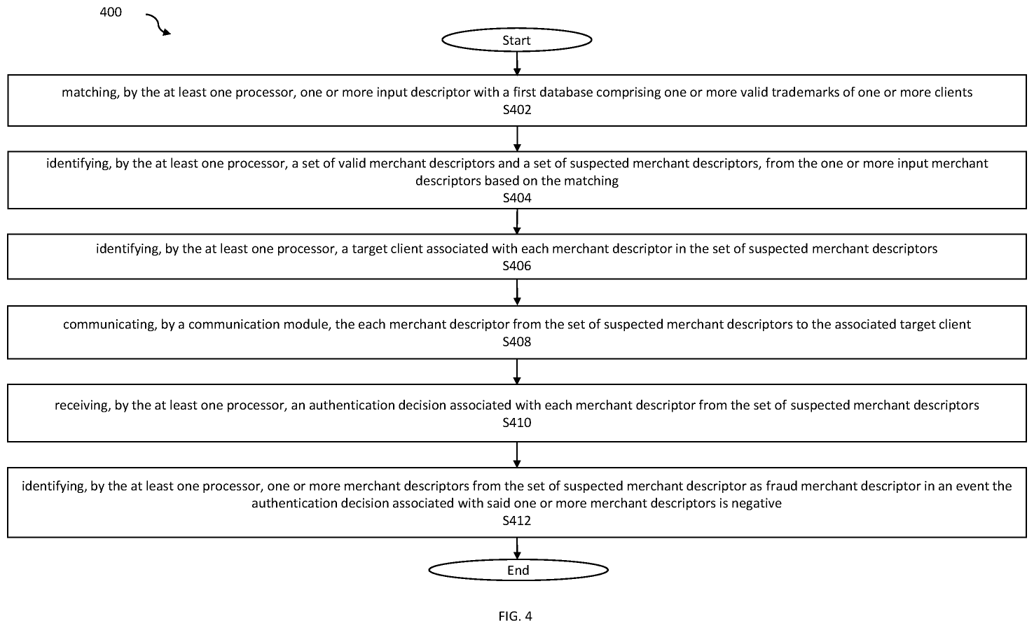

Upon being started, the unauthorized merchant identifier and blocker module 302 executes a process for identifying and blocking transactions from (and on boarding of) merchants associated with fraud merchant descriptors based on an execution of one or more instructions. An exemplary process for implementing a method for identifying fraud merchant descriptors based on an execution of one or more instructions, for this purpose, in accordance with an exemplary embodiment is generally indicated at flowchart 400 in FIG. 4.

Referring to FIG. 4, an exemplary method 400 is shown for identifying fraud merchant descriptors, in accordance with exemplary embodiment of the present disclosure. As shown in FIG. 4, the method begins at step 402 following receipt of a request on a merchant onboarding portal for transaction from a new merchant or for onboarding of a new merchant with the merchant onboarding portal. In accordance with an exemplary embodiment, the one or more input descriptors may appear in a card transaction, wherein the card transaction is one of a credit card transaction, a debit card transaction and a EMV transaction. Thus, at step 402, the method comprises matching, by the at least one processor 104, one or more input descriptor with a first database comprising one or more valid trademarks of one or more clients. The new merchant is associated with a descriptor, here referred to as an input descriptor. Also, a large number of transaction requests may trace to one or more new merchants which could be associated with one or more than one input descriptors. At this step 402, the at least one processor 104 matches each of this one or more input descriptors with the set of valid trademarks stored in the first database. Along with this, the first database 206(1) may also store other information related to the valid trademarks such as merchant descriptor name, acquiring identifiers, and countries, etc.

In a non-limiting embodiment, the first database 206(1) may be stored in the memory unit or server devices 204(1)-204(n). A valid trademark may be the one provided by the client(s) of the merchant service provider. Alternatively, a valid trademark may be the one that is fetched by the system from various platforms such as publicly available databases available on the internet, or other sources such as payment portals hosted by third-party(ies). In another non-limiting embodiment, the one or more input descriptors may be retrieved from one of a second database 206 (2) and a merchant onboarding portal (not shown). The second database 206 (2) may comprise all transactions that have occurred in a predefined period of time in the past, such as for example all transactions that have occurred in the last 24 hours. Further, the one or more input descriptors may be retrieved from a merchant onboarding portal in case where a new merchant tries to onboard with the validation portal of the merchant service provider.

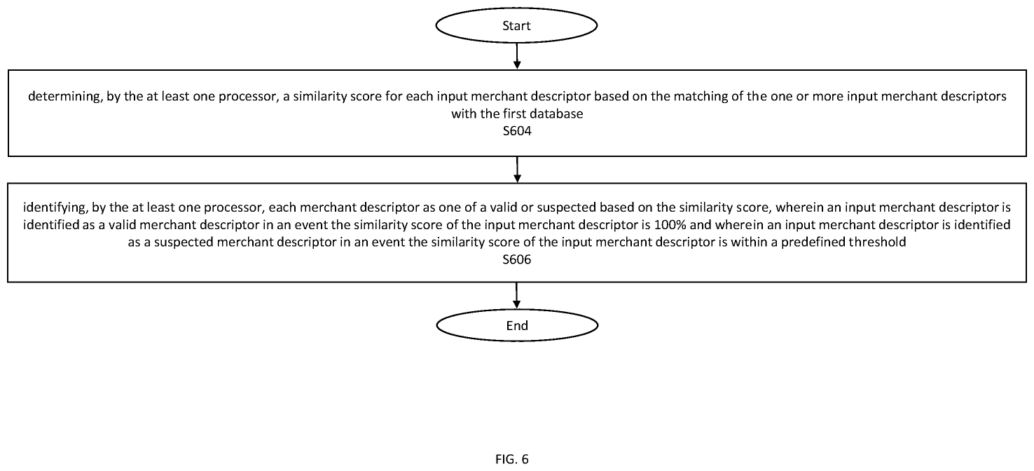

At step 404, the method comprises identifying, by the at least one processor 104, a set of valid merchant descriptors and a set of suspected merchant descriptors, from the one or more input merchant descriptors based on the matching. In a non-limiting embodiment, referring to FIG. 6 which that illustrates an exemplary method for identifying, by the at least one processor, a set of valid merchant descriptors and a set of suspected merchant descriptors, from the one or more input merchant descriptors based on the matching. At step 602, the method comprises determining, by the at least one processor 104, a similarity score for each input merchant descriptor based on the matching of the one or more input merchant descriptors with the first database. Further to this, in this embodiment, at step 604, the method comprises identifying, by the at least one processor 104, each merchant descriptor as one of a valid or suspected based on the similarity score, wherein an input merchant descriptor is identified as a valid merchant descriptor in an event the similarity score of the input merchant descriptor is 100% and wherein an input merchant descriptor is identified as a suspected merchant descriptor in an event the similarity score of the input merchant descriptor is within a predefined threshold. For example, the input merchant descriptor is a valid trademark that is owned by a legitimate client, in this case, the input merchant descriptor will be the exact descriptor as already registered and therefore, there would be an exact match, i.e., 100% match or near to exact match of the input merchant descriptor with the valid merchant descriptor or the valid trademark. In another example, in case the input merchant descriptor is not a valid trademark that is owned by a legitimate client there may be some difference in the input merchant descriptor and the valid trademark owned by a legitimate client, but may not be an exact match. Thus, the similarity score may not be 100% in this case but lie within a predefined threshold range.

Referring back to FIG. 4, after the set of valid merchant descriptors and the set of suspected merchant descriptors are identified, at step 406, the method comprises identifying, by the at least one processor 104, a target client associated with each merchant descriptor in the set of suspected merchant descriptors. Now, for example, a number of suspected merchant descriptors have been identified at step 404. These suspected merchant descriptors may be similar to valid trademarks of different clients associated with the merchant service provider. Thus, the processor 104 in this step 406, identifies for each suspected merchant descriptor as to which client has the valid trademark with which the suspected merchant descriptor is similar. This client that has the valid trademark is referred to as the target client. Thus, each suspected merchant descriptor will have a corresponding target client. For example, a client with valid trademark registered with merchant service provider is ‘ABC’. Now, a request for transaction is received from a new merchant having input merchant descriptor as ‘ABC-XX’. Alternatively, a request for onboarding with the merchant service provider is received from a new merchant having input merchant descriptor as ‘ABC-XX’. Then, the ‘ABC-XX’ may be identified by the processor 104 as the suspected merchant descriptor. In this example, the client ‘ABC’ may be identified as the target client by the processor 104. Similarly a target client will be identified in this step 406, for each merchant descriptor in the set of one or more suspected merchant descriptors.

At step 408, the method comprises, communicating, by a communication module (not shown), the each merchant descriptor from the set of suspected merchant descriptors to the associated target client. The communication module may either operate separately and connected to components of the system or form part of the computer system 102 or any other component of the system as well. The associated target client on reception of the suspected merchant descriptor(s) may make decision regarding authentication of the said suspected merchant descriptor(s), i.e., the target client may decide whether or not the suspected merchant descriptor is a valid descriptor for such target client.

At step 410 the method comprises, receiving, by the at least one processor 104, an authentication decision associated with each merchant descriptor from the set of suspected merchant descriptors. In this, client communicates the decision regarding authentication of the suspected merchant descriptor(s) and communicates the same to the system 102 or to the merchant service provider by other means. If the target client gives a green signal (i.e., authentication decision is positive) saying that the said suspected merchant descriptor(s) is/are their own merchant descriptor(s), then the system allows the transaction to take place and/or to allow the onboarding of the new merchant with the input merchant descriptor. Else, if the client says the suspected merchant descriptor(s) is not theirs, i.e., the authentication decision is negative, the method proceeds further to step 412.

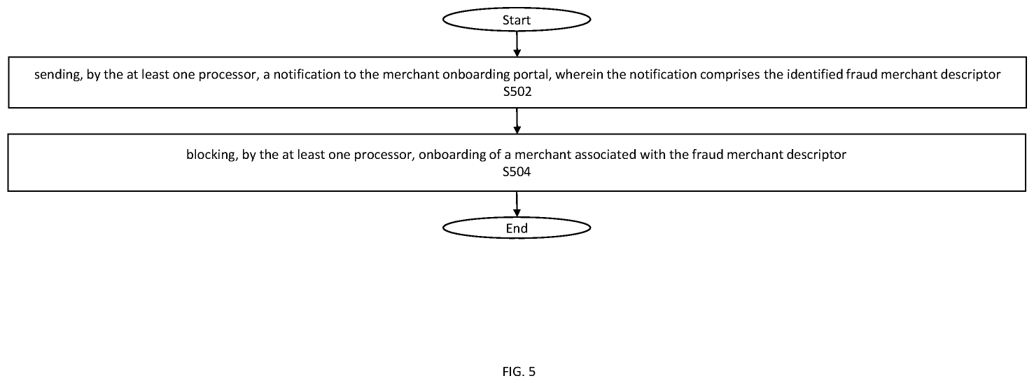

At step 412, the method comprises, identifying, by the at least one processor 104, one or more merchant descriptors from the set of suspected merchant descriptor as fraud merchant descriptor in an event the authentication decision associated with said one or more merchant descriptors is negative. Thus, in this step 412, the processor 104 identifies fraud merchant descriptors. Further to this, the method may comprise steps as shown in FIG. 5. Now referring to FIG. 5, which illustrates an exemplary method for identifying and blocking unauthorized merchants and transactions based on an execution of one or more instructions, in accordance with an exemplary embodiment. In a non-limiting embodiment, on identifying the fraud merchant descriptors, at Step 502, the method may further comprise sending, by the at least one processor 104, a notification to the merchant onboarding portal, wherein the notification comprises the identified fraud merchant descriptor. Further, at step 504, the method comprises blocking, by the at least one processor 104, onboarding of a merchant associated with the fraud merchant descriptor. Alternatively, in this case, had the input merchant descriptor been the one received for making transactions on the payment networks, the transaction is declined. It is pertinent to note for a person skilled in the art that step 502 and step 504 may occur simultaneously or in any order. For example, the notification comprising fraud merchant descriptor may be sent after the onboarding of the new merchant is blocked or transaction is declined. In a non-limiting embodiment, the method further comprises sending, by the at least one processor 104, a notification to one or more payment networks, wherein the notification comprises the identified fraud merchant descriptor.

In a non-limiting embodiment, where a block rule for blocking transactions, on the validation portal, associated with the fraud merchant descriptor, has been applied by the at least one processor 104, the method further comprises automatically blocking, by the at least one processor 104, the transaction request based on the block rule in an event the new merchant descriptor is a fraud merchant descriptor, on receiving, by the at least one processor 104, a new transaction request comprising a new merchant descriptor. Thus, in this embodiment, if a new request for onboarding of a merchant or for a transaction is received, and the processor 104 finds the input merchant descriptor as a fraud merchant descriptor as already saved in a server or memory unit connected to the processor, the processor 104 automatically blocks the onboarding of the merchant or the transaction.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying fraud merchant descriptors, the method being implemented by at least one processor, the method comprising:
matching, by the at least one processor, one or more input descriptor with a first database comprising one or more valid trademarks of one or more clients;
identifying, by the at least one processor, a set of valid merchant descriptors and a set of suspected merchant descriptors, from the one or more input merchant descriptors based on the matching;
identifying, by the at least one processor, a target client associated with each merchant descriptor in the set of suspected merchant descriptors;
communicating, by a communication module, the each merchant descriptor from the set of suspected merchant descriptors to the associated target client;
receiving, by the at least one processor, an authentication decision associated with each merchant descriptor from the set of suspected merchant descriptors; and
identifying, by the at least one processor, one or more merchant descriptors from the set of suspected merchant descriptor as fraud merchant descriptor in an event the authentication decision associated with said one or more merchant descriptors is negative.

2. The method of claim 1 wherein the one or more input descriptor names is retrieved from one of a second database and a merchant onboarding portal.

3. The method of claim 2 further comprising:
sending, by the at least one processor, a notification to the merchant onboarding portal, wherein the notification comprises the identified fraud merchant descriptor; and
blocking, by the at least one processor, onboarding of a merchant associated with the fraud merchant descriptor.

4. The method of claim 2 wherein the second database comprises one or more merchant descriptors retrieved from one or more payment portals.

5. The method of claim 1 wherein identifying, by the at least one processor, a set of valid merchant descriptors and a set of suspected merchant descriptors, from the one or more input merchant descriptors based on the matching, further comprises:
determining, by the at least one processor, a similarity score for each input merchant descriptor based on the matching of the one or more input merchant descriptors with the first database;
identifying, by the at least one processor, each merchant descriptor as one of a valid or suspected based on the similarity score, wherein an input merchant descriptor is identified as a valid merchant descriptor in an event the similarity score of the input merchant descriptor is 100% and wherein an input merchant descriptor is identified as a suspected merchant descriptor in an event the similarity score of the input merchant descriptor is within a predefined threshold.

6. The method of claim 1 further comprising:
applying, by the at least one processor, a block rule for blocking transactions, on the validation portal, associated with the fraud merchant descriptor.

7. The method as claimed in claim 6 further comprising:
receiving, by the at least one processor, a new transaction request comprising a new merchant descriptor; and
automatically blocking, by the at least one processor, the transaction request based on the block rule in an event the new merchant descriptor is a fraud merchant descriptor.

8. The method of claim 1 further comprising:
sending, by the at least one processor, a notification to one or more payment networks, wherein the notification comprises the identified fraud merchant descriptor.

9. The method as claimed in claim 1 wherein the one or more input descriptors appear in a card transaction, wherein the card transaction is one of a credit card transaction, a debit card transaction and a EMV transaction.

10. An apparatus for identifying fraud merchant descriptors, the apparatus comprising:
a processor;
a communication module;
a memory unit connected to the processor and the communication module,
wherein the processor is configured to:
match one or more input descriptor with a first database comprising one or more valid trademarks of one or more clients;
identify a set of valid merchant descriptors and a set of suspected merchant descriptors, from the one or more input merchant descriptors based on the matching;
identify a target client associated with each merchant descriptor in the set of suspected merchant descriptors; and
wherein the communication module is configured to:
communicate the each merchant descriptor from the set of suspected merchant descriptors to the associated target client; and
wherein the processor is configured to:
receive an authentication decision associated with each merchant descriptor from the set of suspected merchant descriptors; and
identify one or more merchant descriptors from the set of suspected merchant descriptor as fraud merchant descriptor in an event the authentication decision associated with said one or more merchant descriptors is negative.

11. The apparatus of claim 10 wherein the one or more input descriptor names is retrieved from one of a second database and a merchant onboarding portal.

12. The apparatus of claim 11 wherein the at least one processor is further configured:
send a notification to the merchant onboarding portal, wherein the notification comprises the identified fraud merchant descriptor; and
block onboarding of a merchant associated with the fraud merchant descriptor.

13. The apparatus of claim 11 wherein the second database comprises one or more merchant descriptors retrieved from one or more payment portals.

14. The apparatus of claim 10 wherein the at least one processor, for identifying a set of valid merchant descriptors and a set of suspected merchant descriptors, from the one or more input merchant descriptors based on the matching, is further configured to:
determine a similarity score for each input merchant descriptor based on the matching of the one or more input merchant descriptors with the first database; and
identify each merchant descriptor as one of a valid or suspected based on the similarity score, wherein an input merchant descriptor is identified as a valid merchant descriptor in an event the similarity score of the input merchant descriptor is 100% and wherein an input merchant descriptor is identified as a suspected merchant descriptor in an event the similarity score of the input merchant descriptor is within a predefined threshold.

15. The apparatus of claim 10, wherein the at least one processor is further configured to:
apply a block rule for blocking transactions, on the validation portal, associated with the fraud merchant descriptor.

16. The apparatus of claim 15 wherein the at least one processor is further configured to:
receive a new transaction request comprising a new merchant descriptor; and
automatically block the transaction request based on the block rule in an event the new merchant descriptor is a fraud merchant descriptor.

17. The apparatus of claim 10 wherein the at least one processor is further configured to:
send a notification to one or more payment networks, wherein the notification comprises the identified fraud merchant descriptor.

18. The apparatus as claimed in claim 10 wherein the one or more input descriptors appear in a card transaction, wherein the card transaction is one of a credit card transaction, a debit card transaction and a EMV transaction.

19. A non-transitory computer readable storage medium storing instructions identifying and blocking unauthorised merchants and transactions, the storage medium comprising executable code which, when executed by a processor, causes the processor to:
match one or more input descriptor with a first database comprising one or more valid trademarks of one or more clients;
identify a set of valid merchant descriptors and a set of suspected merchant descriptors, from the one or more input merchant descriptors based on the matching;
identify a target client associated with each merchant descriptor in the set of suspected merchant descriptors; and
causes the communication module to:
communicate the each merchant descriptor from the set of suspected merchant descriptors to the associated target client; and
further causes the processor to:
receive an authentication decision associated with each merchant descriptor from the set of suspected merchant descriptors; and
identify one or more merchant descriptors from the set of suspected merchant descriptor as fraud merchant descriptor in an event the authentication decision associated with said one or more merchant descriptors is negative.
